(19) United States
(12) Patent Application Publication
(10) Pub. No.: US 2022/0405632 A1
(43) Pub. Date: Dec. 22, 2022

(54) MACHINE LEARNING REPLACEMENTS FOR LEGACY CYBER SECURITY

(71) Applicant: Microsoft Technology Licensing, LLC, One Microsoft Way, WA (US)

(72) Inventors: Idan Y. HEN, Tel Aviv (IL); Roy LEVIN, Haifa (IL)

(21) Appl. No.: 17/354,622

(22) Filed: Jun. 22, 2021

(51) Int. Cl. G06N 20/00; G06F 21/55

(52) U.S. Cl. CPC G06N 20/00; G06F 21/554; G06F 2221/034

(57) ABSTRACT

Generally discussed herein are devices, systems, and methods for improving legacy cyber security solutions. A method can include receiving a sequence of traffic data, the sequence of traffic data representing operations performed by devices communicatively coupled in a network, generating, by cyber security event detection logic, actions corresponding to the sequence of traffic data, the actions corresponding to a cyber security event in the network, creating a training dataset based on the sequence of traffic data, the training dataset including the actions as labels, training a machine learning model based on the training dataset to generate a classification indicating a likelihood of the cyber security event, and distributing the trained machine learning model in place of the cyber security event detection logic.

### BACKGROUND

Many prior cyber security solutions for computer networks operate based on rules defined by a subject matter expert. These rules are essentially if-then statements that map inputs (“if X”) to actions (“then Y”). For each different input type, data is collected and analyzed to determine whether a rule based on that input type indicates an action is to be performed. As the date types scale, the inputs scale, storage capacity required to store the inputs increases, the complexity of the rules increases, and it is likely that the subject matter expert has missed a correlation between some inputs and a malicious behavior. Further, a given computer network can require re-design to provide a new type of data as input or to implement a new rule that detects a cyber security event that might require action. This extra work to provide the data as input increases network activity and consumes valuable bandwidth.

### SUMMARY

A method, device, or machine-readable medium for cloud resource security management can improve upon prior techniques for cyber security. The method, device, or machine-readable medium can replace a rule-based cyber security event detection logic solution with a machine learning model solution. Generating training data for machine learning models can be time consuming or a human-intensive process. Operation of the cyber security event detection logic can be leveraged to generate input/output examples for machine learning model training. The machine learning model solution can find and operate to detect cyber security event correlations that were not present in the rule-based cyber security event detection logic. The machine learning model solution can require less data and less data types to operate than the rule-based cyber security event detection logic. This reduction in data reduces a burden on a data monitor and network traffic used to gather the data. The machine learning model can thus improve network operation when used in place of the rule-based cyber security event detection logic.

A method, device, or machine-readable medium for cloud resource security management can include operations including receiving a sequence of traffic data, the sequence of traffic data representing operations performed by devices communicatively coupled in a network. The operations can further include generating, by cyber security event detection logic, actions corresponding to the sequence of traffic data. The actions can correspond to a cyber security event in the network. The operations can further include creating a training dataset based on the sequence of traffic data. The training dataset can include the actions as labels. The operations can further include training a machine learning model based on the training dataset. The machine learning mode can be trained to generate a classification indicating a likelihood of the cyber security event. The operations can further include distributing the trained machine learning model in place of the cyber security event detection logic.

Creating the training dataset can include reducing the sequence of traffic data to a proper subset of the sequence of traffic data. Reducing the sequence of traffic data can include downsampling the sequence of traffic data. The operations can further include determining features of the sequence of traffic data, and wherein training the machine learning model is performed based on the determined features. Reducing the sequence of traffic data can include performing feature selection on the determined features, resulting in selected features that are a proper subset of the determined features. Training the machine learning model can performed based on the selected features.

The machine learning model can include a neural network, a nearest neighbor classifier, or a Bayesian classifier. The cyber security event detection logic can apply human-defined rules on the sequence of traffic data to determine the actions.

### BRIEF DESCRIPTION OF DRAWINGS

FIG. 1 illustrates, by way of example, a block diagram of an embodiment of a legacy cyber detection system.

FIG. 2 illustrates, by way of example, a diagram of an embodiment of a system for supervised training of a machine learning model that detects cyber security events.

FIG. 3 illustrates, by way of example, a diagram of an embodiment of a system for supervised training of another machine learning model that detects cyber security events with cost of goods sold (COGS) reduced relative to the system of FIG. 1.

FIG. 4 illustrates, by way of example, a block diagram of another embodiment of system that includes reduced COGS relative to the system of FIG. 1.

FIG. 5 illustrates, by way of example, a block diagram of an embodiment of a method for improved cyber security.

FIG. 6 illustrates, by way of example, a block diagram of an embodiment of an environment including a system for neural network training.

FIG. 7 illustrates, by way of example, a block diagram of an embodiment of a machine (e.g., a computer system) to implement one or more embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the embodiments. It is to be understood that other embodiments may be utilized and that structural, logical, and/or electrical changes may be made without departing from the scope of the embodiments. The following description of embodiments is, therefore, not to be taken in a limited sense, and the scope of the embodiments is defined by the appended claims.

One or more embodiments can reduce the data gathering, computational complexity, bandwidth consumption, storage requirements, or a combination thereof, of present rule-based cyber security solutions. Cyber security event detections are an integral part of security products. Many cyber security event detectors alert customers on potentially malicious activity or attacks on their computer resources. Computer resources can include cloud resources, such as compute resources operating on virtual machines, data storage components, application functionality, application servers, a development platform, or the like, on-premises resources, such as a firewall, gateway, printer, desktop computer, access point, mobile compute device (e.g., smart phone, laptop computer, tablet computer, or the like), security system, internet of things (IoT) devices, or the like, or other computer resources, such as external hard drives, smart appliances or other internet capable devices, or the like.

Detecting a cyber security event can include receiving, at detection logic, input data. Such detection logic often depends on a relatively large amount of input data to be collected for it to operate properly, such as network activity including receiving data via a network connection, process creation events, and control plane events. Network activity can include a user accessing a resource, device communication, application communication, storage or access of data, a certificate or secret check, among other activities related to user interaction with the compute resources or data plane events. Process creation events can include application deployment, a user authentication process, launching an application for execution, or the like. Control plane events can include proper or improper user authentication, data routing, load balancing, load analysis, or other network traffic management.

Many prior cyber security solutions for computer networks operate based on rules defined by a subject matter expert. These rules are essentially if-then statements that map inputs (“if X”) to actions (“then Y”). These rules are sometimes called detection logic. For each different input type, data is collected and analyzed using the detection logic to determine whether a rule based on that input type indicates an action is to be performed. As the date types scale, the inputs scale, storage capacity required to store the inputs increases, the complexity of the rules increases, and it is likely that the subject matter expert has missed a correlation between some inputs and a malicious behavior. Further, a given computer network can require re-design to provide a new type of data as input or to implement a new rule that detects a cyber security event that might require action. This extra work to provide the data as input increases network activity and consumes valuable bandwidth.

The process of collecting and saving such data requires management of large amounts of data. Handling the large amounts of data requires a high throughput data pipeline, increased network activity, increased compute capacity, and increased storage capacity. This eventually leads to high cost of goods sold (COGS) of a cyber security event detection and increases the complexity of the cyber security event detection

In a general case, consider D, an existing detection logic. D requires a dataset X to detect a cyber security event. D can be a legacy detection logic that requires a prohibitive amount of data to operate. A goal can be to reduce the COGS in operating the detection logic without sacrificing detection rate or accuracy.

Embodiments can operate by applying D to the full dataset X This will result in a set of predictions, L. L can be used as labels during the training of D′. In some embodiments, X can be sampled. Sampling can include reducing the number of features of X, such as by using feature selection, down-sampling network data, or a combination thereof to produce X′.

To produce D′, a machine learning model can be trained based on X′ and L. Since this procedure is supervised, standard quality metrics, such as precision, recall, area under curve (AUC), or other metric, can be used to ensure the machine learning model is of sufficient quality. Sufficient quality metric means that the model operates to satisfy a criterion based on the quality metric. The criterion can include a user defined threshold or combination of thresholds per quality metric. Embodiments can include fine tune the training if beneficial. The resulting model D′ can operate on a smaller (e.g., sampled) dataset to operate, thus reducing COGS compared to the original detection logic. The end result can be D′, a machine learning model which can reproduce the results of D, with less data collection, data analysis, or a combination thereof.

Embodiments can lower data collection costs of prior cyber security detections. Embodiments can lower data collection costs by training a supervised model to reproduce results of existing cyber security event detection logic over a reduced dataset.

A different approach to reducing COGS of an existing cyber security event detection logic, can include developing a sampled based detection from scratch (without consideration of the previously generated detection logic), but such approach will require a lot of expert manual labor, and might even be intractable, thus wasting the expert manual labor. Embodiments do not require re-developing the cyber security event detection logic. Embodiments can use machine learning tools and much less manual work than prior solutions. Embodiments can leverage prior work in generating the cyber security event detection logic. Embodiments can replace the cyber security event detection logic in a way that allows quality verification and reduces the COGS of the original cyber security event detection logic.

Reference will now be made to the FIGS. to describe further details of embodiments. The FIGS. illustrate examples of embodiments and one or more components of one embodiment can be used with, or in place of, a component of a different embodiment.

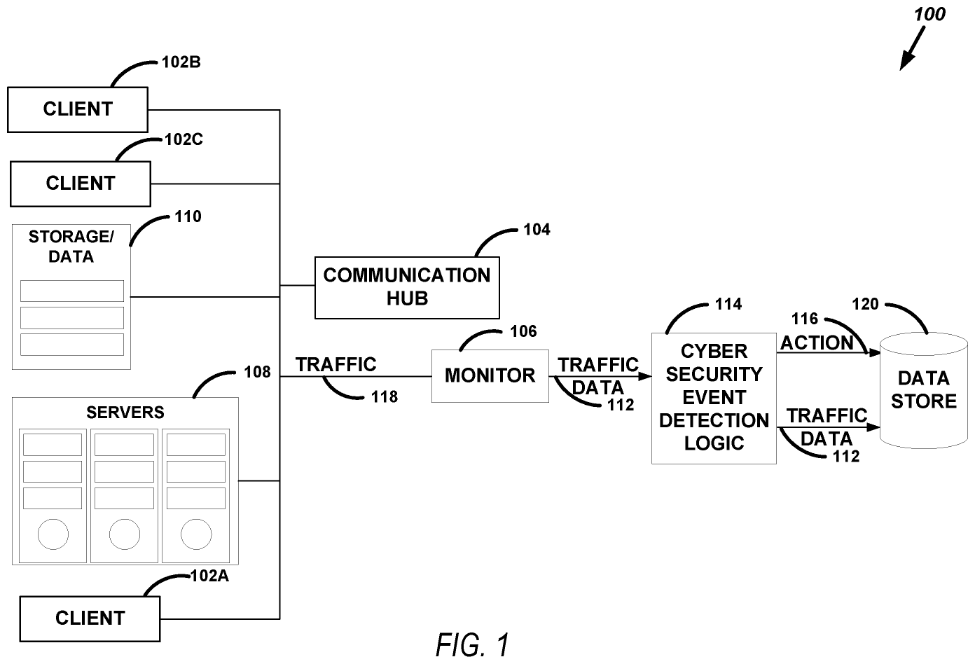

FIG. 1 illustrates, by way of example, a block diagram of an embodiment of a rule-based cyber detection system 100 that can be operated to provide training data. The system 100, as illustrated, includes networked compute devices including clients 102A, 102B, 102C, servers 108, and data storage units 110 communicatively coupled to each other through a communication hub 104. A monitor 106 can analyze traffic 118 between the clients 102A-102C, servers 108, and data storage units 110 and the communication hub 104. Cyber security event detection logic 114 can be communicatively coupled to the monitor 106. The cyber security event detection logic can receive traffic data 112 from the monitor 106.

The clients 102A-102C are respective compute devices capable of communicating with the communication hub 104. The clients 102A-102C can include a smart phone, tablet, laptop, desktop, a server, smart television, thermostat, camera, or other smart appliance, a vehicle (e.g., a manned or unmanned vehicle), or the like. The clients 102A-102C can access the functionality of, or communicate with, another compute device coupled to the communication hub 104.

The communication hub 104 can facilitate communication between the clients 102A-102C, servers 108, and data storage units 110. The communication hub 104 can enforce an access policy that defines which entities (e.g., client devices 102A-102C, servers 108, data storage units 110, or other devices) are allowed to communicate with one another. The communication hub 104 can route traffic 118 that satisfies an access policy (if such an access policy exists) to a corresponding destination.

The monitor 106 can analyze the traffic 118. The monitor 106 can determine based on a body, header, metadata, or a combination thereof of the traffic 118 whether the traffic 118 is pertinent to a rule (e.g., a human-defined rule) enforced by the cyber security event detection logic 114. The monitor 106 can provide the traffic 118 that is pertinent to the rule enforced by the cyber security event detection logic 114 as traffic data 112. The traffic data 112 can include only a portion of the traffic 118, a modified version of the traffic 118, an augmented version of the traffic 118, or the like. The monitor 106 can filter the traffic 118 to only data that is pertinent to the rule for the cyber security event detection logic 114. Even with this filtering, however, the amount of traffic data 112 analyzed by the cyber security event detection logic 114 can be overwhelming, thus reducing the timeliness of the analysis by the cyber security event detection logic 114.

The servers 108 can provide results responsive to a request for computation. The servers 108 can be a file server that provides a file in response to a request for a file, a web server that provides a web page in response to a request for website access, an electronic mail server (email server) that provides contents of an email in response to a request, a login server that provides an indication of whether a username, password, or other authentication data are proper in response to a verification request.

The storage/data unit 110 can include one or more databases, containers, or the like for memory access. The storage/data unit 110 can be partitioned such that a given user has dedicated memory space. A service level agreement (SLA) generally defines an amount of uptime, downtime, maximum or minimum lag in accessing the data, or the like.

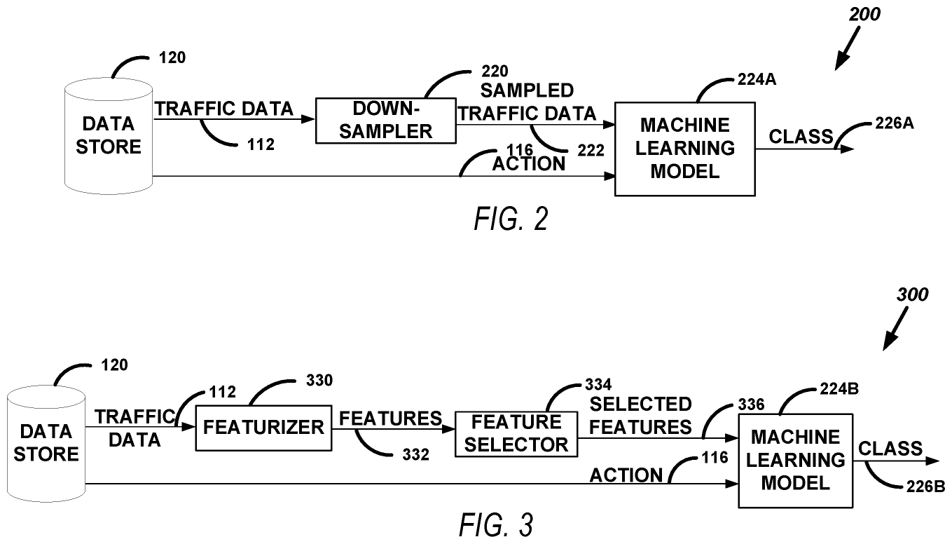

The cyber security event detection logic 114 can perform operations of traffic data 112 analysis. The cyber security event detection logic 114 can identify when pre-defined conditions, associated with a cyber security event, are to determine whether one or more conditions defined for an action 116 are satisfied by the traffic data 112. The conditions can include that a series of operations occurred within a specified time of each other, that a specified number of a same or similar operations occurred within a specified time of each other, a single operation occurred, or the like. The action 116 can indicate a cyber security event. Examples of cyber security events include: (i) data exfiltration, (ii) unauthorized access, (iii) a malicious attack (or potential malicious attack), such as zero day attack, a virus, a worm, a trojan, ransomware, buffer overflow, rootkit, denial of service, man-in-the-middle, phishing, database injection, eavesdropping, port scanning, or the like, or a combination thereof. Each of the cyber security events can correspond to a label (discussed in more detail regarding FIG. 2). Each action 116 can correspond to a label that is used to train a machine learning model that improves upon the COGS of the cyber security event detection logic 114.

A data store 120 can be one of or a portion of the data/storage units 110. The data store 120 can store, for each action 116, corresponding traffic data 112 that caused the action 116 to be detected. The action 116 indicates a cyber security relevant event that occurred in the system 100. The action 116 can be used as a label for supervised training of a machine learning model (see FIGS. 2-3).

FIG. 2 illustrates, by way of example, a diagram of an embodiment of a system 200 for supervised training of a machine learning model 224A that detects cyber security events. Using the machine learning model 224A in place of the cyber security event detection logic 114 can improve upon the operation of the system 100. The improvement can be from reduction in the amount of traffic data 112 used to detect the cyber security event. Such a reduction in the amount of traffic data reduces the burden on the monitor 106 and the provides a detection mechanism that operates on less data than the cyber security event detection logic 114. Such as reduction reduces the COGS of the system.

The data store 120 can provide data that is used to generate input/output examples. The input/output examples, in the example of FIG. 2, can include sampled traffic data 222 as inputs and corresponding actions 116 as outputs. The input/output examples can be used to train the machine learning model 224A. The input/output examples can include the actions 116 as labels for supervised training of the machine learning model 224A.

The traffic data 112 can be provided to a downsampler 220. The downsampler 220 can perform downsampling on the traffic data 112 to generate the sampled traffic data 222. Downsampling is a digital signal processing (DSP) technique performed on a sequence of samples of data. Downsampling the sequence of samples produces an approximation of the sequence that would have been obtained by sampling the signal at a lower rate. Downsampling can include low pass filtering the sequence of samples and decimating the filtered signal by an integer or rational factor.

The machine learning model 224A can receive the sampled traffic data 222 and corresponding action 116 as a label for the sampled traffic data 222. The sampled traffic data 222 can include numeric vectors including binary numbers, integer numbers or real numbers, or a combination thereof. The machine learning model 224 can generate a class 226A estimate. The class 226A can be a confidence vector of classifications that indicates, for each classification, a likelihood it is that the sampled traffic data 222 corresponds to the classification. The classifications can correspond to respective actions 116.

A difference between the classification 226A and the action 116 can be used to adjust parameters (e.g., weights of neurons if the machine learning model 224A is a neural network (NN)) of the machine learning model 224A. The weight adjustment can help the machine learning model 224A produce the correct output (class 226A) given the sampled traffic data 222. More details regarding training and operation of a machine learning model in the form of an NN is provided elsewhere.

FIG. 3 illustrates, by way of example, a diagram of an embodiment of a system 300 for supervised training of another machine learning model 224B that detects cyber security events. Using the machine learning model 224B in place of the cyber security event detection logic 114 can improve upon the operation of the system 100. The improvement can be from reduction in the amount of traffic data 112 used to detect the cyber security event. Such a reduction in the amount of traffic data reduces the burden on the monitor 106 and the provides a detection mechanism that operates on less data than the cyber security event detection logic 114. Such as reduction reduces the COGS of the system.

Similar to the system 200, the data store 120 can provide data that is used to generate input/output examples. The input/output examples, in the example of FIG. 3 can include selected features 336 as inputs and corresponding actions 116 as outputs. The input/output examples can be used to train the machine learning model 224B.

The traffic data 112 can be provided to a featurizer 330. The featurizer 330 can project the N-dimensional traffic data 112 to M-dimensional features 332, where M<N. Features are individual measurable properties or characteristics of a phenomenon. Features are usually numeric. A numeric feature can be conveniently described by a feature vector. One way to achieve classification is using a linear predictor function (related to a perceptron) with a feature vector as input. The method consists of calculating the scalar product between the feature vector and a vector of weights, qualifying those observations whose result exceeds a threshold. The machine learning model 224B can include a nearest neighbor classification, NN, or statistical technique, such as a Bayesian approach.

The features 332 can be provided to a feature selector 334. The feature selector 334 implements a feature selection technique to identify and retain only a proper subset of the features 332.

Feature selection techniques help identify relevant features from the traffic data 112 and remove irrelevant or less important features from the traffic data 112. Irrelevant, or only partially relevant features, can negatively impact performance of the machine learning model 224B. Feature selection reduces chances of overfitting data to the machine learning model 224B, reduces the training time of the machine learning model 224B, and improves accuracy of the machine learning model 224B.

A feature selection technique is a combination of a search technique for proposing new feature subsets, along with an evaluation measure which scores the different feature subsets. A brute force feature selection technique tests each possible subset of features finding the subset that minimizes the error rate. This is an exhaustive search of the space, and is computationally intractable for most feature sets. The choice of evaluation metric heavily influences the feature selection technique. Examples of feature selection techniques include wrapper methods, embedded methods, and filter methods.

Wrapper methods use a predictive model to score feature subsets. Each new subset is used to train a model, which is tested on a hold-out set. Counting the number of mistakes made on that hold-out set (the error rate of the model) gives the score for that subset. As wrapper methods train a new model for each subset, they are very computationally intensive, but provide the best performing feature set for that particular type of model or typical problem.

Filter methods use a proxy measure instead of the error rate to score a feature subset. The proxy measure can be fast to compute, while still capturing the usefulness of the feature set. Common measures include mutual information, pointwise mutual information, Pearson product-moment correlation coefficient, relief-based techniques, and inter/intra class distance. Filter methods are usually less computationally intensive than wrapper methods, but filter methods produce a feature set which is not tuned to a specific type of predictive model. Many filter methods provide a feature ranking rather than an explicit best feature subset. Filter methods have also been used as a preprocessing step for wrapper methods, allowing a wrapper to be used on larger problems. Another feature wrapper method includes using a Recursive Feature Elimination technique to repeatedly construct a model and remove features with low weights.

Embedded methods are a catch-all group of techniques which perform feature selection as part of the model construction process. A least absolute shrinkage and selection operator (LASSO) method for constructing a linear model can penalize regression coefficients with an L1 penalty, shrinking many of them to zero. Any features which have non-zero regression coefficients are ‘selected’ by the LASSO method. Improvements to the LASSO method exist. Embedded methods tend to be between filters and wrappers in terms of computational complexity.

The machine learning model 224B can receive the selected features 336. A corresponding action 116 can serve as a label for the selected features 336. The machine learning model 224B can generate a class 226B estimate. The class 226B can be a confidence vector of classifications that indicates, for each classification of the selected features 336, how likely it is that the selected features 336 correspond to the classification 226B. The classification 226B can correspond to respective actions 116.

A difference between the classification 226B and the action 116 can be used to adjust parameters (e.g., weights of neurons if the machine learning model 224B is an NN, statistical technique, nearest neighbor classifier, or the like) of the machine learning model 224B. The weight adjustment can help the machine learning model 224B produce the correct output (class 226B) given the selected features 336.

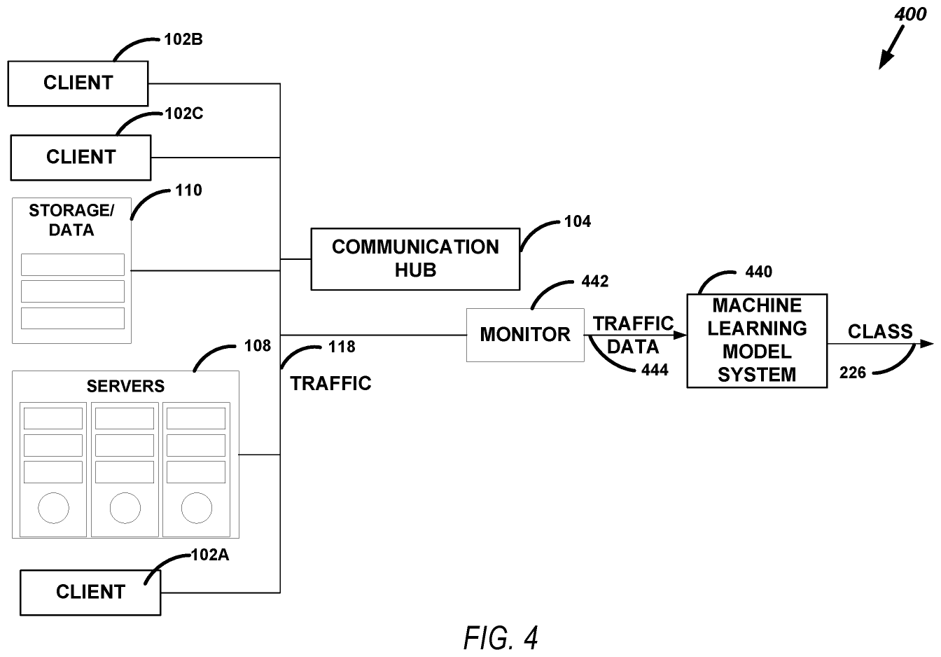

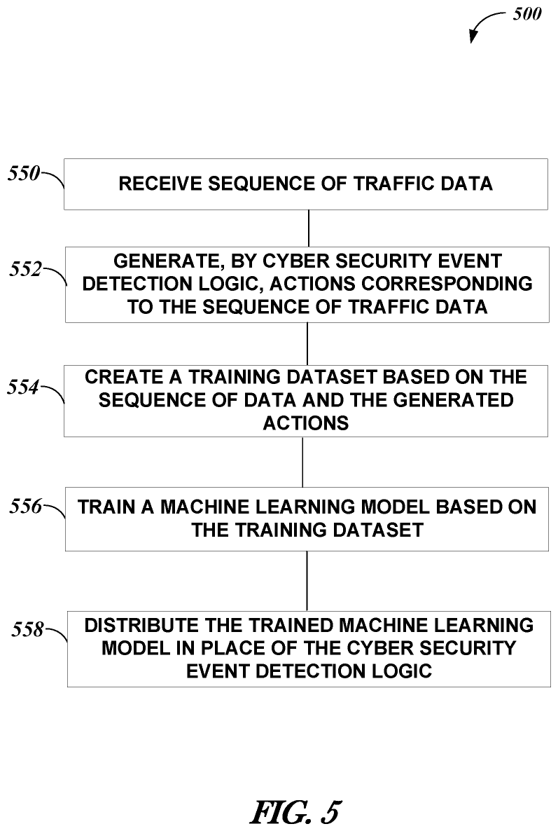

FIG. 4 illustrates, by way of example, a block diagram of an embodiment of a system 400 that includes reduced COGS relative to the system 100 of FIG. 1. The system 400 is similar to the system 100 with a machine learning model system 440 in place of the cyber security event detection logic 114. The machine learning model system 440 can include (i) the downsampler 220, and machine learning model 224A of the system 200 of FIG. 2 or (ii) the featurizer 330, feature selector 334, and machine learning model 224B of the system 300 of FIG. 3. Further, the system 400 can include a monitor 442 in place of the monitor 106. The monitor 442 can be similar to the monitor 106, but is configured to provide traffic data 444 that includes fewer traffic data types than the traffic data 112. This is because the machine learning models 224A, 224B operate with a reduced dataset relative to the cyber security event detection logic 114. The reduced dataset is a consequence of downsampling or feature selection. For example, if a feature selection technique determines that a feature of a traffic data type is not relevant to accurately determine the class 226A, 226B and that traffic data type was retained by the monitor 106 to satisfy only that feature, that traffic data type can be passed on by the monitor 442 and not provided to the machine learning model system 440.

In the FIGS., components with same reference numbers and different suffixes represent different instances of a same general component that is associated with the same reference number without a suffix. So, for example, class 226A and 226B are respective instances of the general class 226.

The monitor 106, 442, communication hub 104, downsampler 220, machine learning model 224A, 224B, featurizer 330, feature selector 334, or other component, can include software, firmware, hardware or a combination thereof. Hardware can include one or more electric or electronic components configured to implement operations of the component. Electric or electronic components can include one or more transistors, resistors, capacitors, diodes, inductors, amplifiers, logic gates (e.g., AND, OR, XOR, buffer, negate, or the like), switches, multiplexers, memory devices, power supplies, analog to digital converters, digital to analog converters, processing circuitry (e.g., central processing unit (CPU), application specific integrated circuit (ASIC), field programmable gate array (FPGA), graphics processing unit (GPU), or the like), a combination thereof, or the like.

FIG. 5 illustrates, by way of example, a block diagram of an embodiment of a method 500 for improved cyber security. The method 500 as illustrated includes receiving a sequence of traffic data, at operation 550; generating, by cyber security event detection logic, actions corresponding to the sequence of traffic data, at operation 552; creating a training dataset based on the sequence of traffic data, at operation 554; based on the training dataset, training a machine learning model, at operation 556; and distributing the trained machine learning model in place of the cyber security event detection logic, at operation 558. The sequence of traffic data can represent operations performed by devices communicatively coupled in a network. The actions can correspond to a cyber security event in the network. The training dataset can include the actions as labels. The machine learning model can be trained to generate a classification indicating a likelihood of the cyber security event.

The operation 554 can include reducing the sequence of traffic data to a proper subset of the sequence of traffic data. Reducing the sequence of traffic data can includes downsampling the sequence of traffic data. The method 500 can further include determining features of the sequence of traffic data. Operation 556 can be performed further based on the determined features. Reducing the sequence of traffic data can include performing feature selection on the determined features, resulting in selected features that are a proper subset of the determined features. The operation 556 can be further performed based on the selected features.

The machine learning model can be a neural network, a nearest neighbor classifier, or a Bayesian classifier. The cyber security event detection logic can apply human-defined rules on the sequence of traffic data to determine the actions. The operation 558 can include using the machine learning model on a same or different machine (or machines) that generated the model.

AI is a field concerned with developing decision-making systems to perform cognitive tasks that have traditionally required a living actor, such as a person. NNs are computational structures that are loosely modeled on biological neurons. Generally, NNs encode information (e.g., data or decision making) via weighted connections (e.g., synapses) between nodes (e.g., neurons). Modern NNs are foundational to many AI applications, such as speech recognition.

Many NNs are represented as matrices of weights that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph—if the threshold is not exceeded then, generally, the value is not transmitted to a down-graph neuron and the synaptic connection remains inactive. The process of weighting and testing continues until an output neuron is reached; the pattern and values of the output neurons constituting the result of the ANN processing.

The correct operation of most NNs relies on accurate weights. However, NN designers do not generally know which weights will work for a given application. NN designers typically choose a number of neuron layers or specific connections between layers including circular connections. A training process may be used to determine appropriate weights by selecting initial weights. In some examples, the initial weights may be randomly selected. Training data is fed into the NN and results are compared to an objective function that provides an indication of error. The error indication is a measure of how wrong the NN's result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

A gradient descent technique is often used to perform the objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

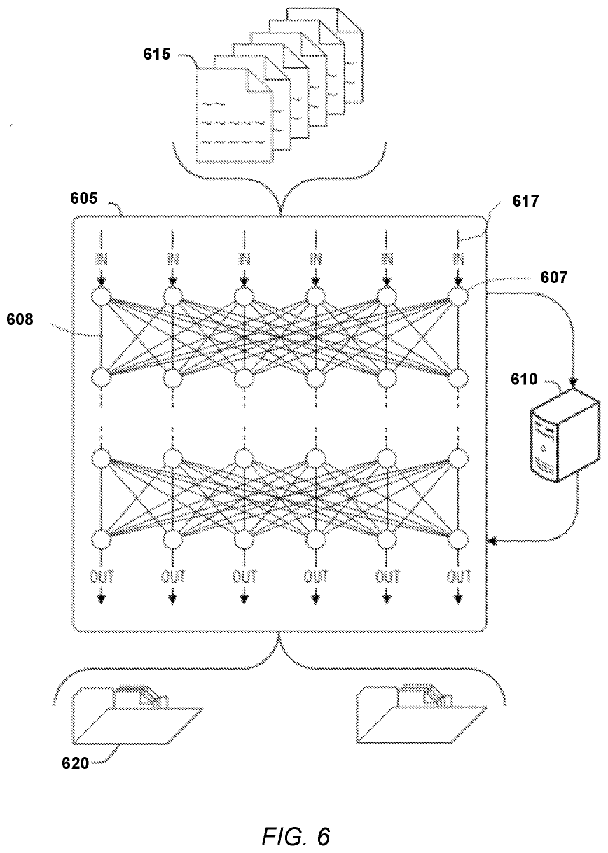

FIG. 6 is a block diagram of an example of an environment including a system for neural network training, according to an embodiment. The system can aid in training of a cyber security solution according to one or more embodiments. The system includes an artificial NN (ANN) 605 that is trained using a processing node 610. The processing node 610 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 605, or even different nodes 607 within layers. Thus, a set of processing nodes 610 is arranged to perform the training of the ANN 605.

The set of processing nodes 610 is arranged to receive a training set 615 for the ANN 605. The ANN 605 comprises a set of nodes 607 arranged in layers (illustrated as rows of nodes 607) and a set of inter-node weights 608 (e.g., parameters) between nodes in the set of nodes. In an example, the training set 615 is a subset of a complete training set. Here, the subset may enable processing nodes with limited storage resources to participate in training the ANN 605.

The training data may include multiple numerical values representative of a domain, such as a word, symbol, other part of speech, or the like. Each value of the training or input 617 to be classified once ANN 605 is trained, is provided to a corresponding node 607 in the first layer or input layer of ANN 605. The values propagate through the layers and are changed by the objective function.

As noted above, the set of processing nodes is arranged to train the neural network to create a trained neural network. Once trained, data input into the ANN will produce valid classifications 620 (e.g., the input data 617 will be assigned into categories), for example. The training performed by the set of processing nodes 607 is iterative. In an example, each iteration of the training the neural network is performed independently between layers of the ANN 605. Thus, two distinct layers may be processed in parallel by different members of the set of processing nodes. In an example, different layers of the ANN 605 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 607 (e.g., neurons) are trained independently. In an example, the nodes are trained on different hardware.

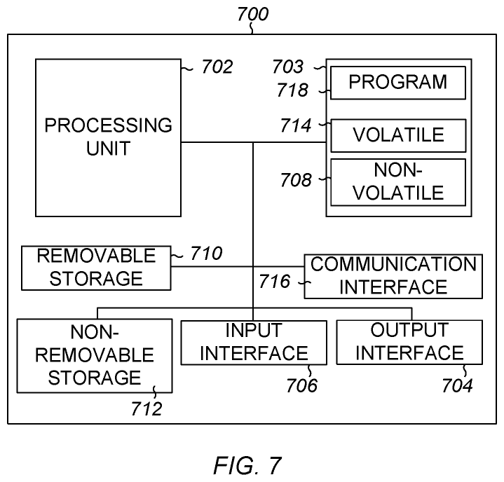

FIG. 7 illustrates, by way of example, a block diagram of an embodiment of a machine 700 (e.g., a computer system) to implement one or more embodiments. The machine 700 can implement a technique for improved cloud resource security. The client 102A-102C, communication hub 104, server 108, storage unit 110, monitor 106, 442, machine learning model system 440, or a component thereof can include one or more of the components of the machine 600. One or more of the client 102A-102C, communication hub 104, server 108, storage unit 110, monitor 106, 442, machine learning model system 440, method 500, or a component or operations thereof can be implemented, at least in part, using a component of the machine 700. One example machine 700 (in the form of a computer), may include a processing unit 702, memory 703, removable storage 710, and non-removable storage 712. Although the example computing device is illustrated and described as machine 700, the computing device may be in different forms in different embodiments. For example, the computing device may instead be a smartphone, a tablet, smartwatch, or other computing device including the same or similar elements as illustrated and described regarding FIG. 7. Devices such as smartphones, tablets, and smartwatches are generally collectively referred to as mobile devices. Further, although the various data storage elements are illustrated as part of the machine 700, the storage may also or alternatively include cloud-based storage accessible via a network, such as the Internet.

Memory 703 may include volatile memory 714 and non-volatile memory 708. The machine 700 may include—or have access to a computing environment that includes—a variety of computer-readable media, such as volatile memory 714 and non-volatile memory 708, removable storage 710 and non-removable storage 712. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices capable of storing computer-readable instructions for execution to perform functions described herein.

The machine 700 may include or have access to a computing environment that includes input 706, output 704, and a communication connection 716. Output 704 may include a display device, such as a touchscreen, that also may serve as an input device. The input 706 may include one or more of a touchscreen, touchpad, mouse, keyboard, camera, one or more device-specific buttons, one or more sensors integrated within or coupled via wired or wireless data connections to the machine 700, and other input devices. The computer may operate in a networked environment using a communication connection to connect to one or more remote computers, such as database servers, including cloud-based servers and storage. The remote computer may include a personal computer (PC), server, router, network PC, a peer device or other common network node, or the like. The communication connection may include a Local Area Network (LAN), a Wide Area Network (WAN), cellular, Institute of Electrical and Electronics Engineers (IEEE) 802.11 (Wi-Fi), Bluetooth, or other networks.

Computer-readable instructions stored on a computer-readable storage device are executable by the processing unit 702 (sometimes called processing circuitry) of the machine 700. A hard drive, CD-ROM, and RAM are some examples of articles including a non-transitory computer-readable medium such as a storage device. For example, a computer program 718 may be used to cause processing unit 702 to perform one or more methods or algorithms described herein.

The operations, functions, or algorithms described herein may be implemented in software in some embodiments. The software may include computer executable instructions stored on computer or other machine-readable media or storage device, such as one or more non-transitory memories (e.g., a non-transitory machine-readable medium) or other type of hardware based storage devices, either local or networked. Further, such functions may correspond to subsystems, which may be software, hardware, firmware, or a combination thereof. Multiple functions may be performed in one or more subsystems as desired, and the embodiments described are merely examples. The software may be executed on a digital signal processor, ASIC, microprocessor, central processing unit (CPU), graphics processing unit (GPU), field programmable gate array (FPGA), or other type of processor operating on a computer system, such as a personal computer, server or other computer system, turning such computer system into a specifically programmed machine. The functions or algorithms may be implemented using processing circuitry, such as may include electric and/or electronic components (e.g., one or more transistors, resistors, capacitors, inductors, amplifiers, modulators, demodulators, antennas, radios, regulators, diodes, oscillators, multiplexers, logic gates, buffers, caches, memories, GPUs, CPUs, field programmable gate arrays (FPGAs), or the like).

### ADDITIONAL NOTES AND EXAMPLES

Example 1 can include a method for cyber security, the method comprising receiving a sequence of traffic data, the sequence of traffic data representing operations performed by devices communicatively coupled in a network, generating, by cyber security event detection logic, actions corresponding to the sequence of traffic data, the actions corresponding to a cyber security event in the network, creating a training dataset based on the sequence of traffic data, the training dataset including the actions as labels, training a machine learning model based on the training dataset to generate a classification indicating a likelihood of the cyber security event, and distributing the trained machine learning model in place of the cyber security event detection logic.

In Example 2, Example 1 can further include, wherein creating the training dataset comprises reducing the sequence of traffic data to a proper subset of the sequence of traffic data.

In Example 3, Example 2 can further include, wherein reducing the sequence of traffic data includes downsampling the sequence of traffic data.

In Example 4, at least one of Examples 2-3 can further include determining features of the sequence of traffic data, and wherein training the machine learning model is performed based on the determined features.

In Example 5, Example 4 can further include, wherein reducing the sequence of traffic data includes performing feature selection on the determined features, resulting in selected features that are a proper subset of the determined features, and wherein training the machine learning model is performed based on the selected features.

In Example 6, at least one of Examples 1-5 can further include, wherein the machine learning model is a neural network, a nearest neighbor classifier, or a Bayesian classifier.

In Example 7, at least one of Examples 1-6 can further include, wherein the cyber security event detection logic applies human-defined rules on the sequence of traffic data to determine the actions.

Example 8 can include a device for performing the method of at least one of Examples 1-7.

Example 9 can include a non-transitory machine-readable medium including instructions that, when executed by a machine, cause the machine to perform operations comprising the method of at least one of Examples 1-7.

Although a few embodiments have been described in detail above, other modifications are possible. For example, the logic flows depicted in the figures do not require the order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A cyber security event detection method comprising:
receiving a sequence of traffic data, the sequence of traffic data representing operations performed by devices communicatively coupled in a network;
generating, by cyber security event detection logic, actions corresponding to the sequence of traffic data, the actions corresponding to a cyber security event in the network;
creating a training dataset based on the sequence of traffic data, the training dataset including the actions as labels;
training a machine learning model based on the training dataset to generate a classification indicating a likelihood of the cyber security event; and
distributing the trained machine learning model in place of the cyber security event detection logic.

2. The method of claim 1, wherein creating the training dataset comprises reducing the sequence of traffic data to a proper subset of the sequence of traffic data.

3. The method of claim 2, wherein reducing the sequence of traffic data includes downsampling the sequence of traffic data.

4. The method of claim 2, further comprising:
determining features of the sequence of traffic data; and
wherein training the machine learning model is performed based on the determined features.

5. The method of claim 4, wherein:
reducing the sequence of traffic data includes performing feature selection on the determined features, resulting in selected features that are a proper subset of the determined features; and
training the machine learning model is performed based on the selected features.

6. The method of claim 1, wherein the machine learning model is a neural network, a nearest neighbor classifier, or a Bayesian classifier.

7. The method of claim 1, wherein the cyber security event detection logic applies human-defined rules on the sequence of traffic data to determine the actions.

8. A compute device comprising:
processing circuitry;
a memory coupled to the processing circuitry, the memory including instructions that, when executed by the processing circuitry, cause the processing circuitry to perform operations for cyber security event detection, the operations comprising:
receiving a sequence of traffic data, the sequence of traffic data representing operations performed by devices communicatively coupled in a network;
generating, by cyber security event detection logic, actions corresponding to the sequence of traffic data, the actions corresponding to a cyber security event in the network;
creating a training dataset based on the sequence of traffic data, the training dataset including the actions as labels;
training a machine learning model based on the training dataset to generate a classification indicating a likelihood of the cyber security event; and
distributing the trained machine learning model in place of the cyber security event detection logic.

9. The device of claim 8, wherein creating the training dataset comprises reducing the sequence of traffic data to a proper subset of the sequence of traffic data.

10. The device of claim 9, wherein reducing the sequence of traffic data includes downsampling the sequence of traffic data.

11. The device of claim 9, wherein the operations further comprise:
determining features of the sequence of traffic data; and
wherein training the machine learning model is performed based on the determined features.

12. The device of claim 11, wherein:
reducing the sequence of traffic data includes performing feature selection on the determined features, resulting in selected features that are a proper subset of the determined features; and
training the machine learning model is performed based on the selected features.

13. The device of claim 9, wherein the machine learning model is a neural network, a nearest neighbor classifier, or a Bayesian classifier.

14. The device of claim 9, wherein the cyber security event detection logic applies human-defined rules on the sequence of traffic data to determine the actions.

15. A non-transitory machine-readable medium including instructions that, when executed by a machine, cause the machine to perform operations for cyber security event detection, the operations comprising:
receiving a sequence of traffic data, the sequence of traffic data representing operations performed by devices communicatively coupled in a network;
generating, by cyber security event detection logic, actions corresponding to the sequence of traffic data, the actions corresponding to a cyber security event in the network;
creating a training dataset based on the sequence of traffic data, the training dataset including the actions as labels;
training a machine learning model based on the training dataset to generate a classification indicating a likelihood of the cyber security event; and
distributing the trained machine learning model in place of the cyber security event detection logic.

16. The non-transitory machine-readable medium of claim 15, wherein creating the training dataset comprises reducing the sequence of traffic data to a proper subset of the sequence of traffic data.

17. The non-transitory machine-readable medium of claim 16, wherein reducing the sequence of traffic data includes downsampling the sequence of traffic data.

18. The non-transitory machine-readable medium of claim 16, further comprising:
determining features of the sequence of traffic data; and
wherein training the machine learning model is performed based on the determined features.

19. The non-transitory machine-readable medium of claim 18, wherein:
reducing the sequence of traffic data includes performing feature selection on the determined features, resulting in selected features that are a proper subset of the determined features; and
training the machine learning model is performed based on the selected features.

20. The non-transitory machine-readable medium of claim 15, wherein the machine learning model is a neural network, a nearest neighbor classifier, or a Bayesian classifier and the cyber security event detection logic applies human-defined rules on the sequence of traffic data to determine the actions.
